(19) United States
(12) Patent Application Publication
(10) Pub. No.: US 2017/0114723 A1
(43) Pub. Date: Apr. 27, 2017

(54) DEVICE FOR ASSISTING A SOLID PROPELLANT PROPULSION SYSTEM OF A SINGLE-ENGINE HELICOPTER, SINGLE-ENGINE HELICOPTER COMPRISING SUCH A DEVICE

(71) Applicants: SAFRAN AIRCRAFT ENGINES, Paris (FR); SAFRAN HELICOPTER ENGINES, BORDES (FR); SAFRAN CERAMICS, LE HAILLAN (FR)

(72) Inventors: Patrick Marconi, Gelos (FR); Romain Thiriet, Jurancon (FR); Camel Serghine, Boeil-Bezing (FR); Francois Danguy, Moissy-cramayel Cedex (FR); Philippe Barrat, Saint Medard En Jalles (FR); Jean-Louis Besse, Nay (FR); Pascal Guillemet, Mazeres-Lezons (FR); Guillaume Demezon, Bordeaux (FR); Jean-Michel Sannino, Moissy-cramayel Cedex (FR); Nicolas Marucheau De Chanaud, Moissy-cramayel Cedex (FR)

(21) Appl. No.: 15/301,939

(22) PCT Filed: Apr. 3, 2015
(86) PCT No.: PCT/FR2015/050878

§ 371 Date: Oct. 4, 2016

(30) Foreign Application Priority Data
Apr. 8, 2014 (FR) 1453123

(51) Int. Cl. F02C 7/36; F02C 3/10; F02C 7/266

(52) U.S. Cl. CPC F02C 7/36; F02C 7/266; F02C 3/10; F05D 2220/329; F05D 2270/09; F05D 2260/40

(57) ABSTRACT

The invention relates to a device for assisting a propulsion system of a single-engine helicopter, comprising an engine connected to a power transmission gearbox (15) suitable for rotating a rotor (88) of the helicopter, characterised in that it comprises: a turbine (18) for driving in rotation an output shaft (34) that is mechanically connected to said power transmission gearbox (15); and controlled means (16) for supplying said drive turbine (18) with pressurised fluid in order to allow said turbine (18) to transform the power from said pressurised fluid into mechanical power for rotating said output shaft (34).

### 1. TECHNICAL FIELD OF THE INVENTION

The invention relates to a device and to a method for assisting a propulsion system of a single-engine helicopter. A device of this type is in particular intended to assist a single-engine helicopter during autorotational flight following the failure of the helicopter engine, it being possible for said engine to be a turboshaft engine, a combustion engine or an electric motor.

### 2. TECHNOLOGICAL BACKGROUND

A single-engine helicopter is a helicopter that is equipped with just one turboshaft engine or internal combustion engine. When the single engine of a helicopter of this type fails during a mission, the pilot has to very rapidly follow a degraded flight procedure known as autorotational flight.

In practice, this procedure is complicated to implement, in particular the step that aims to reduce the collective pitch at the start of the manoeuvre and the step that aims to synchronise the action on the collective pitch and the approach towards the ground at the end of the manoeuvre. Incidentally, statistics show that, in practice, more than 50% of autorotations carried out by pilots lead to damage to the helicopter.

There is therefore a need to provide a device for assisting a single-engine helicopter that can be used during autorotational flight or that makes it possible to secure the passage into autorotational flight if the single engine of a single-engine helicopter fails.

### 3. AIMS OF THE INVENTION

The invention aims to provide a device for assisting a propulsion system of a single-engine helicopter that makes it possible to assist a single-engine helicopter during autorotational flight in the event of the engine stopping in an uncontrolled manner.

The invention also aims to provide, in at least one embodiment, a device of this type that does not have a notable impact on the total weight of the helicopter.

The invention also aims to provide a method for assisting a propulsion system of a single-engine helicopter.

### 4. DISCLOSURE OF THE INVENTION

To do this, the invention relates to a device for assisting a propulsion system of a single-engine helicopter, comprising an engine connected to a power transmission gearbox suitable for rotating a rotor of the helicopter, said engine comprising a gas generator, a free turbine connected to the gas generator, a speed reduction gearbox and a free wheel, referred to as a power free wheel, connected to said power transmission gearbox, said assistance device comprising:
a turbine for driving in rotation an output shaft suitable for being mechanically connected to said power transmission gearbox,
controlled means for supplying said drive turbine (18) with pressurised fluid in order to allow said turbine to transform the energy from said pressurised fluid into mechanical power for rotating said output shaft,
   characterised in that said assistance device further comprises a free wheel suitable for being arranged between said output shaft of said drive turbine and said power transmission gearbox in one of the following configurations:
a configuration in which it is directly connected to said power transmission gearbox,
a configuration in which it is directly connected to a shaft arranged between said power free wheel of said turboshaft engine and said power transmission gearbox,
a configuration in which it is directly connected to a shaft arranged between said speed reduction gearbox of said turboshaft engine and said power free wheel of said turboshaft engine,
a configuration in which it is directly connected to a shaft arranged between said free turbine and said speed reduction gearbox of said turboshaft engine.

A device according to the invention therefore allows the power transmission gearbox (hereinafter referred to as PTG) to be provided with mechanical power when necessary. A device of this type is therefore particularly suitable for mechanically assisting the helicopter during autorotational flight, in particular during the final phases of flight.

Furthermore, a device of this type comprises a drive turbine and means for supplying this turbine with fluid. This is equipment that is small in size and has a negligible weight compared with the total weight of a helicopter. It can therefore be installed in a single-engine helicopter without having a detrimental effect on the performance of the helicopter. This equipment is also more reliable, meaning that a device according to the invention is robust and reliable.

The use of a device according to the invention therefore makes it possible to make autorotational flights of a helicopter more reliable and to substantially improve the rate of landings that take place without damage, which would require the helicopter to be immobilised for a long period of time.

A device according to the invention also allows for a plurality of configurations. For example, according to one configuration, it comprises a reduction gearbox and a free wheel that are arranged between the output shaft of the drive turbine and the power transmission gearbox (PTG).

According to another configuration, the free wheel is directly connected to said power transmission gearbox. A configuration of this type has the advantage of it being possible to provide the surplus power as closely as possible to the PTG and, in this configuration, of it being suitable for other types of engines, such as an internal combustion engine. The assistance device therefore makes it possible to mitigate failures of all the engine elements located upstream of the PTG.

According to another configuration, the free wheel is directly connected to a shaft arranged between said power free wheel of said engine and said power transmission gearbox. A configuration of this type also has the advantage of it being possible to provide the surplus power as closely as possible to the input of the PTG. Compared with the preceding configuration, this configuration also has the advantage of providing a connection to a shaft arranged within the engine perimeter.

According to another configuration, the free wheel is directly connected to a shaft arranged between said speed reduction gearbox of said engine and said power free wheel of said engine. A configuration of this type has the advantage of remaining within the engine perimeter. However, it does not make it possible to mitigate a potential failure of the power free wheel.

According to another configuration, the device does not comprise a reduction gearbox. A device of this type only comprises a free wheel directly connected to a shaft upstream of the speed reduction gearbox of the engine. A configuration of this type has the advantage of not requiring a speed reduction gearbox that is specific to the assistance device, given that it uses that of the engine. This allows a saving in terms of space and weight.

Advantageously and according to the invention, said controlled means for supplying said turbine with fluid comprise pneumatic, hydraulic, pyrotechnic and/or electrical means, depending on the circumstances.

A drive turbine for a device according to the invention may be of any type. In particular, it is supplied with a pressurised gaseous fluid. The means for controlling the warm-up of said turbine may be pneumatic, hydraulic, electrical or pyrotechnic.

Advantageously and according to the invention, said controlled means for supplying the drive turbine comprise:
at least one solid-propellant gas generator comprising a gas outlet connected to an inlet of the drive turbine,
at least one device for igniting an electrically controlled gas generator.

Controlled means of this type for supplying the drive turbine with pressurised fluid use new technology that comprises a solid-propellant gas generator. A generator of this type is relatively compact and can be easily integrated for example either in a turboshaft engine or at other points along the chain for transmitting power to the main transmission gearbox. A solid propellant allows high-energy combustion products to be generated by combustion (oxidation-reduction reaction). Controlled means of this type for supplying the drive turbine have a high power and energy density compared with an accumulator, for example. Furthermore, supply means of this type benefit from complete autonomy from the electrical network of the helicopter.

When the engine fails, the device for igniting the gas generator is activated at the appropriate time by the pilot (at the very start of the failure in order to counteract a sudden drop in rotor revolution, or close to the ground). This activation results in the solid-propellant gas generator starting up. The gases produced by the generator rotate the turbine for driving the output shaft, and therefore the power transmission gearbox that is mechanically connected to this output shaft.

An assistance device according to this variant of the invention thus makes it possible to rapidly assist a single-engine helicopter that has lost the use of its engine by providing the power that allows the drive to the power transmission gearbox and therefore to the rotor system of the helicopter to be maintained. A device of this type can be actuated either at the start of autorotation in order to assist the pilot in the critical phase that aims to reduce the collective pitch or at the end of autorotation during the phase that aims to synchronise the action on the collective pitch and the approach towards the ground.

Advantageously and according to the invention, the device comprises a plurality of solid-propellant gas generators such that there are a plurality of separate sources for providing power, and such that it is possible to successively activate said device.

Advantageously and according to this variant, the means for supplying the drive turbine further comprise a dispensing valve controlled by an electronics module connecting the gas outlet of a gas generator to the inlet of the drive turbine.

The invention also relates to an architecture of a propulsion system of a single-engine helicopter, characterised in that it comprises at least one assistance device according to the invention.

Advantageously and according to a variant of the invention, the architecture of the propulsion system comprises:
a turboshaft engine comprising a gas generator, a free turbine supplied by said gas generator, a speed reduction gearbox arranged at the output of the free turbine, and a free wheel, referred to as a power free wheel, arranged between the speed reduction gearbox and a power transmission gearbox,
an assistance device according to the invention comprising a free wheel that is arranged between the output shaft of the drive turbine and the input of the speed reduction gearbox of the turboshaft engine.

Advantageously and according to another variant of the invention, the architecture of the propulsion system comprises:
a turboshaft engine comprising a gas generator, a free turbine supplied by said gas generator, a speed reduction gearbox arranged at the output of the free turbine, and a free wheel, referred to as a power free wheel, arranged between the speed reduction gearbox and a power transmission gearbox,
an assistance device according to the invention comprising a reduction gearbox and a free wheel that are arranged between the output shaft of the drive turbine and the power transmission gearbox.

The invention also relates to a helicopter comprising a propulsion system, characterised in that said propulsion system has an architecture according to the invention.

The invention also relates to a method for assisting a propulsion system of a single-engine helicopter comprising an engine which is connected to a power transmission gearbox suitable for rotating a rotor of the helicopter, characterised in that it comprises:
a step of controlling the supply of pressurised fluid to a drive turbine that is mechanically connected to said power transmission gearbox,
a step of transforming, by means of said drive turbine, the power from the pressurised fluid into mechanical power to rotate said power transmission gearbox.

The invention also relates to an assistance method, to an architecture of a propulsion system and to a helicopter, characterised in combination by all or some of the features mentioned above or below.

### 5. LIST OF DRAWINGS

Other aims, features and advantages of the invention will become apparent upon reading the following description, which is given purely by way of non-limiting example and relates to the accompanying drawings, in which:

FIG. 1 is a schematic view of a device for assisting a propulsion system of a single-engine helicopter according to an embodiment of the invention,

FIG. 2 is a schematic view of an architecture of a propulsion system according to an embodiment of the invention comprising an assistance device according to an embodiment of the invention,

FIG. 3 is a schematic view of an architecture of a propulsion system according to another embodiment of the invention comprising an assistance device according to an embodiment of the invention,

FIG. 4 is a schematic view of an architecture of a propulsion system according to another embodiment of the invention comprising an assistance device according to an embodiment of the invention,

FIG. 5 is a schematic view of an architecture of a propulsion system according to another embodiment of the invention comprising an assistance device according to another embodiment of the invention,

FIG. 6 is a schematic view of an architecture of a propulsion system according to another embodiment of the invention comprising an assistance device according to another embodiment of the invention.

### 6. DETAILED DESCRIPTION OF AN EMBODIMENT OF THE INVENTION

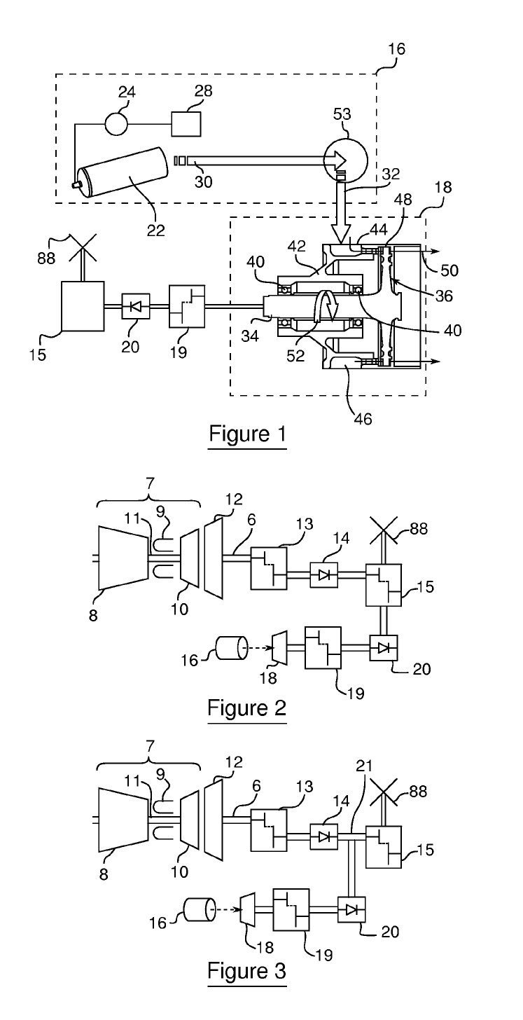

An assistance device according to the invention comprises, as shown in FIG. 1, a turbine 18 for driving in rotation an output shaft 34 that is mechanically connected to the power transmission gearbox 15 of a helicopter, which is in turn connected to a rotor 88 of the helicopter.

It also comprises controlled means 16 for supplying the drive turbine 18 with pressurised fluid in order to allow the turbine 18 to transform the energy from said pressurised fluid into mechanical power for rotating the output shaft 34.

According to the embodiment in FIG. 1, the controlled means 16 for supplying the drive turbine 18 are pyrotechnic means. They comprise a solid-propellant gas generator 22, a device 24 for igniting solid propellant, which is electrically controlled, and a computer 28 connected to the ignition device 24. The gas outlet of the generator 22 is connected by a conduit to an inlet 44 of the drive turbine 18.

In this case, the gas generator 22 comprises a cylindrical body containing one or more solid-propellant charges that are of a shape adapted to the desired gas mass flow law of the generator, this body serving as a combustion chamber. It should be noted that the desired mass flow law can be obtained by means of an appropriate selection of the shape of the charge and/or by totally or partially inhibiting certain parts of the charge.

After igniting the surface of the propellant charge, the surface of the charge burns and advances by producing high-pressure combustion gases in accordance with the mass flow law resulting from the shape and the inhibition of the charge. The gases are discharged at the outlet of the generator and are conveyed to the inlet 44 of the turbine 18. The course of the gases is represented by the arrows 30 and 32.

The ignition device 24 is electrically controlled by the computer 28 and is intended to activate the combustion of the propellant once a corresponding signal is emitted by the computer 28.

The computer 28 is an electronic control module such as those commonly used in the field of aeronautics. When the pilot detects a loss of power on the single turboshaft engine of the single-engine helicopter, the pilot sends a command to the computer 28, which activates the ignition device 24 such that the drive turbine 18 is supplied with the combustion gases generated by the combustion of the solid propellant.

The drive turbine 18 is for example a turbine of the supersonic type. It essentially comprises a shaft 34 supporting a rotor wheel 36, the shaft 34 being guided in rotation by bearings 40 mounted in a casing 42 of the turbine. The casing 42 comprises a radial opening forming the inlet 44 of the turbine 18 and leading into an annular cavity 46 for supplying the turbine. This cavity 46 may have a constant cross section from upstream to downstream or may, by contrast, have a cross section that changes from upstream to downstream, this cavity being optimised by a person skilled in the art.

The combustion gases that penetrate the cavity 46 expand and flow through the blades 48 of the wheel 36 (arrows 50), and this rotates the wheel 36 and therefore the shaft 34 about its axis (arrow 52). The gases then leave the turbine 18 through an exhaust nozzle of said turbine and are discharged to the outside (arrows 50). A filter 53 may be mounted upstream of the turbine so as to limit the introduction of solid particles into the duct of the turbine.

The shaft 34 makes it possible to transmit a torque to the power transmission gearbox 15 by means of a reduction gearbox 19 and a free wheel 20.

According to other embodiments, the drive turbine may be an inward flow turbine, and generally any type of rotating machine that makes it possible to transform the power from a fluid into mechanical power. It may for example be a spur-pinion engine, as described in the patent application FR2990004 in the name of the applicant.

FIGS. 2 to 6 show various embodiments of the architecture of a propulsion system of a helicopter comprising an assistance device according to the invention. These different architectures demonstrate different coupling configurations between the shaft 34 and the power transmission gearbox 15. In FIGS. 2 to 6, the turbine 18 and the means 16 for controlling and generating energy fluids are not shown in detail for reasons of clarity.

According to the embodiment in FIGS. 2 to 6, the propulsion system comprises either an internal combustion engine or a turboshaft engine formed by a gas generator 7 supplying a free turbine 12, a speed reduction gearbox 13 and a free wheel 14, referred to as a power free wheel, connected to the power transmission gearbox 15. As is known, the gas generator 7 comprises at least one air compressor 8 that supplies a chamber 9 for combusting fuel in the compressed air and which supplies hot gases to at least one turbine 10 for partially expanding the gases, which turbine rotates the compressor 8 by means of a drive shaft 11. The gases then drive the free power transmission turbine 12. This free turbine 12 comprises a power transmission shaft 6 that is connected to the power transmission gearbox 15 by means of the speed reduction gearbox 13 and the power free wheel 14. This power free wheel 14 makes it possible to prevent mechanical locking of the turboshaft engine from causing mechanical locking of the power transmission gearbox 15 and, by extension, of the rotor of the helicopter on which said turboshaft engine is mounted.

FIG. 2 shows an embodiment in which the free wheel 20 is directly connected to the power transmission gearbox 15. This embodiment is also suitable for an internal combustion engine.

FIG. 3 shows an embodiment in which the free wheel 20 is connected to a shaft 21 arranged between the power free wheel 14 of the turboshaft engine and the power transmission gearbox 15. This embodiment is also suitable for an internal combustion engine.

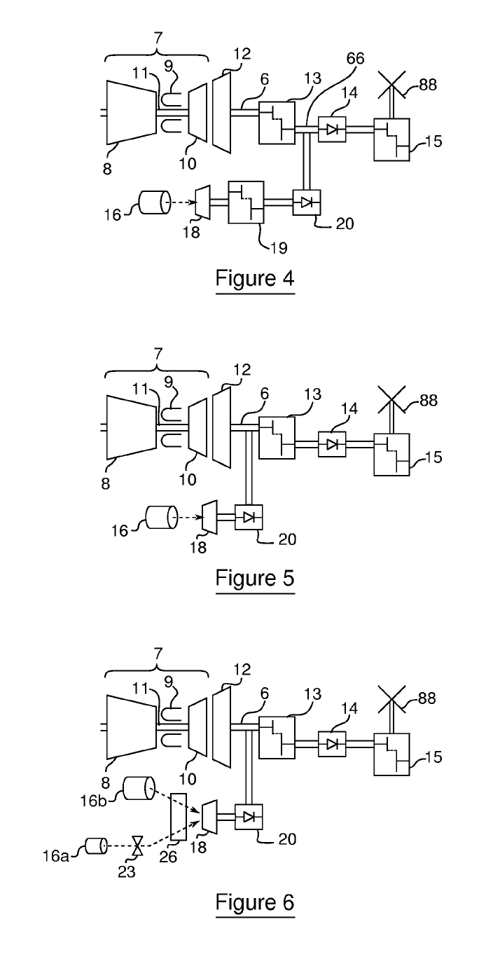

FIG. 4 shows an embodiment in which the free wheel 20 is connected to the output or to an intermediate stage of the speed reduction gearbox 13 of the turboshaft engine. This mechanical connection between the free wheel 20 and the output of the reduction gearbox 13 is represented by the shaft 66 in FIG. 4.

FIG. 5 shows an embodiment in which the free wheel 20 is connected to the input of the speed reduction gearbox 13 of the turboshaft engine. According to this embodiment, the assistance device does not comprise a specific reduction gearbox. This mechanical connection between the free wheel 20 and the input of the reduction gearbox 13 is represented by the shaft 6 in FIG. 5.

Lastly, FIG. 6 shows an embodiment in which the assistance device comprises at least two solid-propellant gas generators 16a, 16b.

An assistance device of this type forms a multi-stroke system, which therefore has more power than a single-stroke system. In the case of this multi-stroke system, the controlled means for supplying the drive turbine 18 may comprise, in addition to the solid-propellant gas generators 16a, 16b, a dispensing valve 26 connecting the gas outlet of the gas generators to the inlet 44 of the drive turbine 18, so as to select which gas generator supplies the drive turbine 18. The computer that makes it possible to control the ignition device of the gas generators is therefore connected to this valve 26 so that it can be controlled.

According to another variant, an isolation valve 23 is arranged between the generator 16a and the turbine 18 in order to protect the generator 16a while the generator 16b is in operation. A variant of this type is particularly suitable when it is always the generator 16b that operates first.

According to another variant (not shown in the drawings), and if it has not been determined which generator will operate first, two isolation valves 23 are arranged between the generator 16a and the turbine 18, and between the generator 16b and the turbine 18, respectively. A variant of this type makes it possible to protect each generator while the other generator is in operation.

FIG. 6 simultaneously shows an isolation valve 23 and a dispensing valve 26 for reasons of clarity. That being said, it is not necessary for these two valves to be present at the same time. In other words, three architectures are possible: an architecture in which two isolation valves are provided; an architecture in which a single isolation valve is provided if it is always the same generator that is activated first; and an architecture in which a single dispensing valve is provided.

The invention also relates to a method for assisting a propulsion system of a single-engine helicopter comprising a turboshaft engine which is connected to a power transmission gearbox suitable for rotating a rotor of the helicopter. A method of this type comprises a step of controlling the supply of pressurised fluid to a drive turbine that is mechanically connected to said power transmission gearbox, and a step of transforming, by means of said drive turbine, the power from the pressurised fluid into mechanical power to rotate said power transmission gearbox.

The control order for supplying pressurised fluid to the drive turbine 18 is executed by the pilot of the helicopter by means of a switch in the cockpit. This switch for example makes it possible to use a dedicated electrical network to power the computer 28, which acts as a pyrotechnic initiator, if the turbine is being supplied by gases originating from a solid-propellant gas generator as described in connection with FIG. 1.

In order to prevent the assistance device from being activated accidentally, the control means may be configured such that the control order is not executed if at least one predetermined condition is not fulfilled. Each predetermined condition is characterised by a situation that makes driving the PTG by means of the system dangerous or ineffective, taking into account the flight conditions.

For example, logical combinations of the following conditions are provided in order to prevent the control order from being executed:
the helicopter flies at an altitude greater than a minimum altitude Hₛₒₗ_{_}ₘᵢₙ (for example, 100 feet),
the rotational speed NR of the rotor is greater than a minimum predetermined rotational speed NRₘᵢₙ (for example, NRₘᵢₙ from the flight manual).

Of course, other conditions may be provided according to the requirements and depending on the safeguards that need to be put in place.

The invention is not limited to only the described embodiments. In particular, according to other embodiments, the assistance device may comprise a plurality of solid-propellant gas generators such that the drive turbine can be supplied by either of the generators. This makes it possible for there to be additional power by means of at least two different routes, potentially at two different moments during flight (at the start and the end of the autorotational procedure, for example). In addition, this makes it possible for there to be storage devices of different sizes, and this also allows the desired profile to be adjusted.

1. A device for assisting a propulsion system of a single-engine helicopter, comprising an engine connected to a power transmission gearbox suitable for rotating a rotor of the helicopter, said engine comprising a gas generator, a free turbine connected to the gas generator, a speed reduction gearbox and a free wheel, referred to as a power free wheel, connected to said power transmission gearbox, said assistance device comprising:
a turbine for driving in rotation an output shaft suitable for being mechanically connected to said power transmission gearbox,
controlled means for supplying said drive turbine with pressurised fluid in order to allow said turbine to transform the energy from said pressurised fluid into mechanical power for rotating said output shaft,
wherein said assistance device further comprises a free wheel suitable for being arranged between said output shaft of said drive turbine and said power transmission gearbox in one of the following configurations:
a configuration in which it is directly connected to said power transmission gearbox,
a configuration in which it is directly connected to a shaft arranged between said power free wheel of said turboshaft engine and said power transmission gearbox,
a configuration in which it is directly connected to a shaft arranged between said speed reduction gearbox of said turboshaft engine and said power free wheel of said turboshaft engine,
a configuration in which it is directly connected to a shaft arranged between said free turbine and said speed reduction gearbox of said turboshaft engine.

2. The device according to claim 1, wherein said controlled supply means of said drive turbine comprise pneumatic, hydraulic, pyrotechnic and/or electrical means.

3. The device according to claim 1, wherein said controlled supply means of said drive turbine comprise:
at least one solid-propellant gas generator comprising a gas outlet connected to an inlet of the drive turbine,
at least one device for igniting an electrically controlled gas generator.

4. The device according to claim 1, wherein it comprises a plurality of solid-propellant gas generators such that there are a plurality of separate sources for providing power.

5. The device according to claim 3, wherein it comprises a plurality of solid-propellant gas generators such that there are a plurality of separate sources for providing power, wherein said means for supplying said drive turbine further comprise a dispensing valve controlled by an electronics module connecting the gas outlet of the gas generators to the inlet of the drive turbine.

6. The architecture of a propulsion system of a single-engine helicopter, wherein it comprises at least one assistance device according to claim 1.

7. A helicopter comprising a propulsion system, wherein said propulsion system has an architecture according to claim 6.
